(19) United States
(12) Patent Application Publication
(10) Pub. No.: US 2023/0396293 A1
(43) Pub. Date: Dec. 7, 2023

(54) METHOD AND APPARATUS FOR TRANSMITTING DATA IN WIRELESS COMMUNICATION SYSTEM

(71) Applicant: ELECTRONICS AND TELECOMMUNICATIONS RESEARCH INSTITUTE, Daejeon (KR)

(72) Inventors: Chan ho YOON, Daejeon (KR); Young Jo KO, Daejeon (KR); Kap Seok CHANG, Daejeon (KR); Won Cheol CHO, Daejeon (KR)

(73) Assignee: ELECTRONICS AND TELECOMMUNICATIONS RESEARCH INSTITUTE, Daejeon (KR)

(21) Appl. No.: 18/328,166

(22) Filed: Jun. 2, 2023

(30) Foreign Application Priority Data
Jun. 3, 2022 (KR) 10-2022-0068078
May 30, 2023 (KR) 10-2023-0069170

(51) Int. Cl. H04B 7/04; H04B 7/06

(52) U.S. Cl. CPC H04B 7/04026; H04B 7/0621

(57) ABSTRACT

A method of a transmitting node may comprise: modulating a codeword corresponding to data to be transmitted; generating sparse space-frequency block code (SSFBC)-coded symbols by encoding the modulated codeword in an SSFBC scheme; performing precoding on the SSFBC-coded symbols for each of subbands respectively corresponding to transmit antenna groups; and transmit the precoded SSFBC-coded symbols by performing beamforming on the precoded SSFBC-coded symbols using at least one array antenna group among two or more array antenna groups.

### CROSS-REFERENCE TO RELATED APPLICATIONS

This application claims priority to Korean Patent Applications No. 10-2022-0068078, filed on Jun. 3, 2022, and No. 10-2023-0069170, filed on May 30, 2023, with the Korean Intellectual Property Office (KIPO), the entire contents of which are hereby incorporated by reference.

### BACKGROUND

### 1. Technical Field

Exemplary embodiments of the present disclosure relate to a technique for data transmission in a wireless communication system, and more specifically, to a technique for transmitting and receiving data using a beamforming technique.

### 2. Related Art

In Ultra-Reliability Low-Latency Communication (URLC) as one of the representative application scenarios of New Radio (NR), which is 5G mobile communication, a radio link block error rate (BER) equal to or less than 10⁻⁵ and a user plane latency equal to or less than 1 ms are targeted. The representative applications of the 5G NR URLLC may include factory automation, vehicle-to-vehicle communication, and the like. Some factory automation machines require high reliability of a BLER per communication link of less than 10⁻⁹ and an end-to-end (E2E) communication latency of less than 1 ms.

To achieve ultra-reliability and low-latency simultaneously in wireless communication, the quality of the radio channel between a base station and a terminal should satisfy certain requirements. In general, transmission techniques that ensure a high received power using sufficient radio resources should be employed. Specifically, a system needs to be designed to enable transmission with guaranteed reliability even to terminals operating in environments with a signal-to-noise ratio (SNR) lower than 5% in the radio channel.

### SUMMARY

An objective of the present disclosure for solving the above-described needs is to provide a method and an apparatus for transmitting data based on a beamforming technique using a small amount of feedback information.

A method of a transmitting node according to an exemplary embodiment of the present disclosure may comprise: modulating a codeword corresponding to data to be transmitted; generating sparse space-frequency block code (SSFBC)-coded symbols by encoding the modulated codeword in an SSFBC scheme; performing precoding on the SSFBC-coded symbols for each of subbands respectively corresponding to transmit antenna groups; and transmitting the precoded SSFBC-coded symbols by performing beamforming on the precoded SSFBC-coded symbols using at least one array antenna group among two or more array antenna groups.

The number of the subbands may be determined based on the number of radio frequency (RF) chains.

The precoding may be determined based on feedback information received from a receiving node, and the feedback information may include phase value(s) for lowering a condition number (CN) measured by the receiving node based on a signal received from the transmitting node to a minimum value.

A method of a first transmitting node, according to an second exemplary embodiment of the present disclosure, may comprise: modulating a codeword corresponding to data to be transmitted; generating sparse space-frequency block code (SSFBC)-coded symbols by encoding the modulated codeword in an SSFBC scheme; performing precoding on the SSFBC-coded symbols for each of subbands respectively corresponding to transmit antenna groups based on first feedback information related to the first transmitting node and second feedback information related to a second transmitting node; and transmitting the precoded SSFBC-coded symbols by performing beamforming on the precoded SSFBC-coded symbols using at least one array antenna group among two or more array antenna groups based on the first feedback information and the second feedback information.

The method may further comprise: determining a transmit power based on the first feedback information and the second feedback information, wherein the precoded SSFBC-coded symbols may be transmitted using the determined transmit power.

The first feedback information may include information on a zenith of departure (ZoD) and an angle of departure (AoD), which is information of a transmission beam direction.

The first transmitting node and the second transmitting node may be transmission and reception points (TRPs) that transmit data to a same receiving node.

Each of the first feedback information and the second feedback information may include interference penalty information of a different transmitting node performing cooperative transmission.

The second feedback information may include information on a transmit power of the second transmitting node.

The number of the subbands may be determined based on the number of radio frequency (RF) chains.

A first transmitting node according to an second exemplary embodiment of the present disclosure may comprise a processor, and the processor may cause the first transmitting node to perform: modulating a codeword corresponding to data to be transmitted; generating sparse space-frequency block code (SSFBC)-coded symbols by encoding the modulated codeword in an SSFBC scheme; performing precoding on the SSFBC-coded symbols for each of subbands respectively corresponding to transmit antenna groups based on first feedback information related to the first transmitting node and second feedback information related to a second transmitting node; and transmitting the precoded SSFBC-coded symbols by performing beamforming on the precoded SSFBC-coded symbols using at least one array antenna group among two or more array antenna groups based on the first feedback information and the second feedback information.

The processor may cause the first transmitting node to perform: determining a transmit power based on the first feedback information and the second feedback information, wherein the precoded SSFBC-coded symbols may be transmitted using the determined transmit power.

The first feedback information may include information on a zenith of departure (ZoD) and an angle of departure (AoD), which is information of a transmission beam direction.

The first transmitting node and the second transmitting node may be transmission and reception points (TRPs) that transmit data to a same receiving node.

Each of the first feedback information and the second feedback information may include interference penalty information of a different transmitting node performing cooperative transmission.

The second feedback information may include information on a transmit power of the second transmitting node.

The number of the subbands is determined based on the number of radio frequency (RF) chains.

According to the present disclosure, when spatial diversity is to be achieved using a massive transmit antenna, a transmitting node can obtain a desired spatial diversity gain by adjusting the number of beamforming groups. In addition, since a wireless communication system according to the present disclosure requires feedback components having low complexity, it has an effect of reducing overhead. In addition, the limited feedback can contribute to reliability improvement by reducing the amount of uplink transmission.

### BRIEF DESCRIPTION OF DRAWINGS

FIG. 1 is a conceptual diagram illustrating an exemplary embodiment of a communication system.

FIG. 2 is a block diagram illustrating an exemplary embodiment of a communication node constituting a communication system.

FIG. 3 is a conceptual diagram illustrating a transmitting node and a receiving node for describing an SSFBC transmission scheme to which a beamforming scheme is applied according to the present disclosure.

FIG. 4A is a conceptual diagram illustrating main configuration of a transmitting node for transmitting signals based on SSFBC according to the present disclosure.

FIG. 4B is a conceptual diagram illustrating modulated signals output from a modulation unit according to the present disclosure.

FIG. 5 is a diagram illustrating a case in which multiple antennas of a transmitting node are configured as cross-pole antennas according to an exemplary embodiment of the present disclosure.

FIG. 6 is a conceptual diagram illustrating main configuration of a receiving node for receiving signals based on SSFBC according to the present disclosure.

FIG. 7 is a conceptual diagram for describing a distributed panel multi-point transmission scheme for a terminal located at a cell edge according to the present disclosure.

### DETAILED DESCRIPTION OF THE EMBODIMENTS

Exemplary embodiments of the present disclosure are disclosed herein. However, specific structural and functional details disclosed herein are merely representative for purposes of describing exemplary embodiments of the present disclosure. Thus, exemplary embodiments of the present disclosure may be embodied in many alternate forms and should not be construed as limited to exemplary embodiments of the present disclosure set forth herein.

Accordingly, while the present disclosure is capable of various modifications and alternative forms, specific exemplary embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular exemplary embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication system to which exemplary embodiments according to the present disclosure are applied will be described. The communication system to which the exemplary embodiments according to the present disclosure are applied is not limited to the contents described below, and the exemplary embodiments according to the present disclosure may be applied to various communication systems. Here, the communication system may have the same meaning as a communication network.

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present specification, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

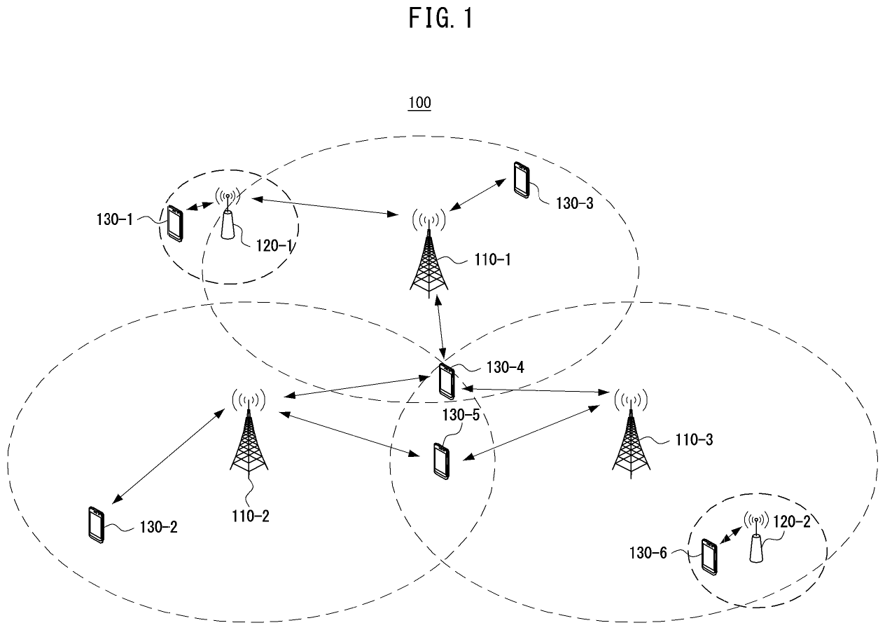

FIG. 1 is a conceptual diagram illustrating an exemplary embodiment of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes may support 4th generation (4G) communication (e.g., long term evolution (LTE), LTE-advanced (LTE-A)), 5th generation (5G) communication (e.g., new radio (NR)), or the like. The 4G communication may be performed in a frequency band of 6 gigahertz (GHz) or below, and the 5G communication may be performed in a frequency band of 6 GHz or above as well as the frequency band of 6 GHz or below.

For example, for the 4G and 5G communications, the plurality of communication nodes may support a code division multiple access (CDMA) based communication protocol, a wideband CDMA (WCDMA) based communication protocol, a time division multiple access (TDMA) based communication protocol, a frequency division multiple access (FDMA) based communication protocol, an orthogonal frequency division multiplexing (OFDM) based communication protocol, a filtered OFDM based communication protocol, a cyclic prefix OFDM (CP-OFDM) based communication protocol, a discrete Fourier transform spread OFDM (DFT-s-OFDM) based communication protocol, an orthogonal frequency division multiple access (OFDMA) based communication protocol, a single carrier FDMA (SC-FDMA) based communication protocol, a non-orthogonal multiple access (NOMA) based communication protocol, a generalized frequency division multiplexing (GFDM) based communication protocol, a filter bank multi-carrier (FBMC) based communication protocol, a universal filtered multi-carrier (UFMC) based communication protocol, a space division multiple access (SDMA) based communication protocol, or the like.

In addition, the communication system 100 may further include a core network. When the communication system 100 supports the 4G communication, the core network may comprise a serving gateway (S-GW), a packet data network (PDN) gateway (P-GW), a mobility management entity (MME), and the like. When the communication system 100 supports the communication, the core network may comprise a user plane function (UPF), a session management function (SMF), an access and mobility management function (AMF), and the like.

Meanwhile, each of the plurality of communication nodes 110-1, 110-2, 110-3, 120-1, 120-2, 130-1, 130-2, 130-3, 130-4, 130-5, and 130-6 constituting the communication system 100 may have the following structure.

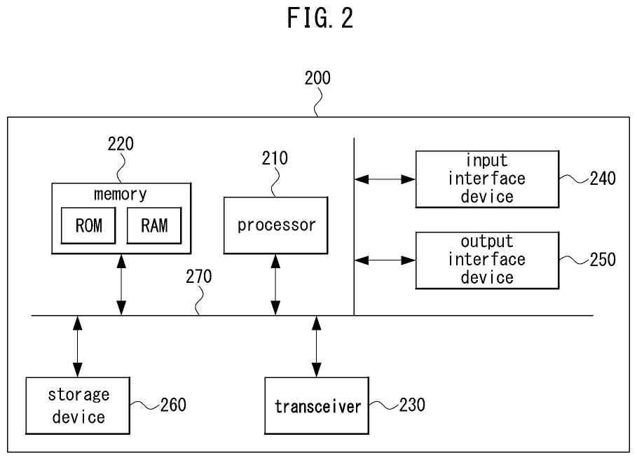

FIG. 2 is a block diagram illustrating an exemplary embodiment of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may be connected to the processor 210 via an individual interface or a separate bus, rather than the common bus 270. For example, the processor 210 may be connected to at least one of the memory 220, the transceiver 230, the input interface device 240, the output interface device 250, and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed. Each of the memory 220 and the storage device 260 may be constituted by at least one of a volatile storage medium and a non-volatile storage medium. For example, the memory 220 may comprise at least one of read-only memory (ROM) and random access memory (RAM).

Referring again to FIG. 1, the communication system 100 may comprise a plurality of base stations 110-1, 110-2, 110-3, 120-1, and 120-2, and a plurality of terminals 130-1, 130-2, 130-3, 130-4, 130-5, and 130-6. The communication system 100 including the base stations 110-1, 110-2, 110-3, 120-1, and 120-2 and the terminals 130-1, 130-2, 130-3, 130-4, 130-5, and 130-6 may be referred to as an ‘access network’. Each of the first base station 110-1, the second base station 110-2, and the third base station 110-3 may form a macro cell, and each of the fourth base station 120-1 and the fifth base station 120-2 may form a small cell. The fourth base station 120-1, the third terminal 130-3, and the fourth terminal 130-4 may belong to cell coverage of the first base station 110-1. Also, the second terminal 130-2, the fourth terminal 130-4, and the fifth terminal 130-5 may belong to cell coverage of the second base station 110-2. Also, the fifth base station 120-2, the fourth terminal 130-4, the fifth terminal 130-5, and the sixth terminal 130-6 may belong to cell coverage of the third base station 110-3. Also, the first terminal 130-1 may belong to cell coverage of the fourth base station 120-1, and the sixth terminal 130-6 may belong to cell coverage of the fifth base station 120-2.

Here, each of the plurality of base stations 110-1, 110-2, 110-3, 120-1, and 120-2 may refer to a Node-B, a evolved Node-B (eNB), a base transceiver station (BTS), a radio base station, a radio transceiver, an access point, an access node, a road side unit (RSU), a radio remote head (RRH), a transmission point (TP), a transmission and reception point (TRP), an eNB, a gNB, or the like.

Here, each of the plurality of terminals 130-1, 130-2, 130-3, 130-4, 130-5, and 130-6 may refer to a user equipment (UE), a terminal, an access terminal, a mobile terminal, a station, a subscriber station, a mobile station, a portable subscriber station, a node, a device, an Internet of things (IoT) device, a mounted apparatus (e.g., a mounted module/device/terminal or an on-board device/terminal, etc.), or the like.

Meanwhile, each of the plurality of base stations 110-1, 110-2, 110-3, 120-1, and 120-2 may operate in the same frequency band or in different frequency bands. The plurality of base stations 110-1, 110-2, 110-3, 120-1, and 120-2 may be connected to each other via an ideal backhaul or a non-ideal backhaul, and exchange information with each other via the ideal or non-ideal backhaul. Also, each of the plurality of base stations 110-1, 110-2, 110-3, 120-1, and 120-2 may be connected to the core network through the ideal or non-ideal backhaul. Each of the plurality of base stations 110-1, 110-2, 110-3, 120-1, and 120-2 may transmit a signal received from the core network to the corresponding terminal 130-1, 130-2, 130-3, 130-4, 130-5 or 130-6, and transmit a signal received from the corresponding terminal 130-1, 130-2, 130-3, 130-4, 130-5, or 130-6 to the core network.

In addition, each of the plurality of base stations 110-1, 110-2, 110-3, 120-1, and 120-2 may support multi-input multi-output (MIMO) transmission (e.g., a single-user MIMO (SU-MIMO), multi-user MIMO (MU-MIMO), massive MIMO, or the like), coordinated multipoint (CoMP) transmission, carrier aggregation (CA) transmission, transmission in an unlicensed band, device-to-device (D2D) communications (or, proximity services (ProSe)), or the like. Here, each of the plurality of terminals 130-1, 130-2, 130-3, 130-4, 130-5, and 130-6 may perform operations corresponding to the operations of the plurality of base stations 110-1, 110-2, 110-3, 120-1, and 120-2, and operations supported by the plurality of base stations 110-1, 110-2, 110-3, 120-1, and 120-2. For example, the second base station 110-2 may transmit a signal to the fourth terminal 130-4 in the SU-MIMO manner, and the fourth terminal 130-4 may receive the signal from the second base station 110-2 in the SU-MIMO manner. Alternatively, the second base station 110-2 may transmit a signal to the fourth terminal 130-4 and fifth terminal 130-5 in the MU-MIMO manner, and the fourth terminal 130-4 and fifth terminal 130-5 may receive the signal from the second base station 110-2 in the MU-MIMO manner.

The first base station 110-1, the second base station 110-2, and the third base station 110-3 may transmit a signal to the fourth terminal 130-4 in the CoMP transmission manner, and the fourth terminal 130-4 may receive the signal from the first base station 110-1, the second base station 110-2, and the third base station 110-3 in the CoMP manner. Also, each of the plurality of base stations 110-1, 110-2, 110-3, 120-1, and 120-2 may exchange signals with the corresponding terminals 130-1, 130-2, 130-3, 130-4, 130-5, or 130-6 which belongs to its cell coverage in the CA manner. Each of the base stations 110-1, 110-2, and 110-3 may control D2D communications between the fourth terminal 130-4 and the fifth terminal 130-5, and thus the fourth terminal 130-4 and the fifth terminal 130-5 may perform the D2D communications under control of the second base station 110-2 and the third base station 110-3.

Hereinafter, methods and apparatuses for transmitting and receiving data will be described. Even when a method (e.g., transmission or reception of a data packet) performed at a first communication node among communication nodes is described, the corresponding second communication node may perform a method (e.g., reception or transmission of the data packet) corresponding to the method performed at the first communication node. That is, when an operation of a terminal is described, a corresponding base station may perform an operation corresponding to the operation of the terminal. Conversely, when an operation of a base station is described, a corresponding terminal may perform an operation corresponding to the operation of the base station.

Meanwhile, in a communication system, a base station may perform all functions (e.g., remote radio transmission/reception function, baseband processing function, and the like) of a communication protocol. Alternatively, the remote radio transmission/reception function among all the functions of the communication protocol may be performed by a transmission reception point (TRP) (e.g., flexible (f)-TRP), and the baseband processing function among all the functions of the communication protocol may be performed by a baseband unit (BBU) block. The TRP may be a remote radio head (RRH), radio unit (RU), transmission point (TP), or the like. The BBU block may include at least one BBU or at least one digital unit (DU). The BBU block may be referred to as a ‘BBU pool’, ‘centralized BBU’, or the like. The TRP may be connected to the BBU block through a wired fronthaul link or a wireless fronthaul link. The communication system composed of backhaul links and fronthaul links may be as follows. When a functional split scheme of the communication protocol is applied, the TRP may selectively perform some functions of the BBU or some functions of medium access control (MAC)/radio link control (RLC) layers.

In Ultra-Reliability Low-Latency Communication (URLC) as one of the representative application scenarios of New Radio (NR), which is 5G mobile communication, a radio link block error rate (BER) equal to or less than 10⁻⁵ and a user plane latency equal to or less than 1 ms are targeted. The representative applications of the 5G NR URLLC may include factory automation, vehicle-to-vehicle communication, and the like. Some factory automation machines require high reliability of a BLER per communication link of less than 10⁻⁹ and an end-to-end (E2E) communication latency of less than 1 ms.

To achieve ultra-reliability and low-latency simultaneously in wireless communication, the quality of the radio channel between a base station and a terminal should satisfy certain requirements. In general, transmission techniques that ensure a high received power using sufficient radio resources should be employed. Specifically, a system needs to be designed to enable transmission with guaranteed reliability even to terminals operating in environments with a signal-to-noise ratio (SNR) lower than 5% in the radio channel.

Therefore, a multi-antenna system is sometimes employed to ensure sufficient radio quality for all terminals in a given region and meet the requirements. The quality of the radio channel can be enhanced by utilizing multiple antennas both in the transmitter and receiver of the multi-antenna system. By combining the multi-antenna system with an encoding code, the reliability of the radio channel can be increased, and one of the techniques for achieving this is the use of space-time codes.

When using a multi-antenna scheme like the space-time code, the receiver captures signals that combine frequency-domain antenna component signals transmitted by the transmitter. Therefore, the receiver receives combined signals resulting from the transmission of signals using multiple antennas, wherein signals from different antennas are superimposed. Consequently, the level of signal superimposition may increase proportionally with the number of antennas employed by the transmitter. Hence, the receiver needs to separate and demodulate the desired signal from the received superimposed signals. The receiver should demodulate the received signal after separating it, with the complexity increasing in accordance with the number of superimposed signals and the number of signal components and channel estimates to be demodulated may rise correspondingly with the number of antennas (or radio frequency (RF) chains).

Therefore, in the case of a space-time block code where the number of transmit antennas N t is large and the number of receive antennas Nᵣ is small, the number of superimposed signals increases with the increasing number of transmit antennas. As a result, in the aforementioned scenario with a large number of transmit antennas and a small number of receive antennas, the complexity of the receiver exponentially grows as the number of superimposed signals to be processed by the receiver increases. This increase in complexity can lead to demodulation delays in the receiver.”

When using a multi-input multi-output (MIMO) decoder as a sub-optimal solution to reduce the aforementioned delay problem and receiver complexity, and to efficiently utilize power, there can be a significant deterioration in decoding performance. Specifically, in scenarios where the transmitter can employ a large number of transmit antennas while the receiver has a limited number of antennas, the complexity of separating and demodulating superimposed signals at the receiver remains high. However, the smaller number of receive antennas in the receiver may lead to a fundamental issue where the performance is prone to rapid deterioration. Furthermore, channel estimation entails significant overhead in order to mitigate estimation errors, particularly in environments with a large number of transmit antennas and a small number of receive antennas.

In the aforementioned scenario, specifically when the number of transmit antennas (or RF chains) is high while the number of receive antennas (or RF chains) is low, it can lead to significant challenges when applying URLLC as an application scenario. In other words, in wireless communication systems, a design approach aiming to enhance the reliability of the wireless channel may involve utilizing a large number of transmit antennas (or RF chains) to achieve transmit spatial diversity gains.

However, a problem may occur in the environment in which the receiver receiving signals transmitted through a large number of transmit antennas should demodulate the signals through a relatively small number of receive antennas.

In such environments, degradation in the demodulation performance of the receiver is commonly observed. Particularly in scenarios where the number of receive antennas is fewer than the number of transmit antennas in the setup, if conventional space-time code techniques are applied, the issues with the receiver's decoder mentioned above may arise. Additionally, in the process of reducing the substantial channel estimation overhead caused by the asymmetry between the number of transmit and receive antennas, there can be inaccuracies in the estimated channel coefficients. Consequently, in the described environment, these factors can contribute to a degradation in wireless signal transmission performance in URLLC scenarios. This phenomenon represents a critical issue of significant importance.

Therefore, in wireless communication environments where there are multiple transmit antennas and a relatively small number of receive antennas, a solution that utilizes the multiple transmit antennas to achieve transmit spatial diversity is necessary. In other words, a solution that can improve the quality of the wireless channel is required. Particularly, a URLLC communication method that combines spatial diversity with the maximization of diversity based on the channel states of subcarriers, considering the varying signal-to-noise ratio (SNR) response across frequencies, is needed. This method would involve transmitting by maximizing diversity using subcarriers while incorporating techniques such as orthogonal frequency-division multiplexing (OFDM).

On the other hand, traditional general space-time block code wireless transmission systems have effectively achieved spatial diversity by utilizing only one antenna bound to the RF chain in frequency bands below 6 GHz. This has increased the reliability of signal transmission. However, for frequencies above 6 GHz, there is significant free space attenuation (such as path loss) and severe attenuation caused by reflection off objects. Therefore, in wireless communication systems using frequencies above 6 GHz, the rich scattering environment suitable for conventional multiple antennas is not readily available, making it difficult to acquire diversity through multiple antenna transmission or increase transmission capacity through multi-layer transmission. Hence, in wireless communication systems using frequencies above 6 GHz, it is common to apply beamforming by concentrating the energy of the radio waves to compensate for the propagation attenuation of the wireless channel, rather than employing multiple antennas for diversity gain or multi-layer transmission for increased capacity.

However, when using beamforming, although it allows for the acquisition of array gain generated by applying multiple antennas, it fails to obtain the channel diversity that is closely related to the reliability required for URLLC.

When applying digital beamforming using singular value decomposition (SVD) in the baseband, both array gain and diversity gain can be obtained. However, in order to derive a precoding matrix for SVD, accurate knowledge of a transmit channel's state should be available in advance. There is no method to precisely know the transmit channel's state. Additionally, even if it is assumed that the channel remains unchanged, a feedback overhead required to obtain the precoding matrix is quite significant. Therefore, the practical implementation of digital beamforming through SVD is not straightforward.

Furthermore, if feedback transmission is required to obtain the precoding matrix, it can introduce a significant overhead and lead to substantial interference in the uplink channel. This can ultimately decrease the overall reliability.

Therefore, there is a need for a system that operates above 6 GHz with limited feedback overhead while obtaining channel diversity and array gain. Additionally, a system combining space-time codes and beamforming, which can achieve channel diversity in the frequency bands below 6 GHz, has not been proposed. Although space-time codes provide a means of acquiring diversity without the need for feedback overhead in an open-loop fashion, obtaining transmit channel diversity is challenging due to the characteristics of the channel above 6 GHz.

Furthermore, channel diversity can also be achieved by using a Distributed Antenna System (DAS). In a DAS, multiple antennas connected to a single base station are deployed at geographically different locations. Particularly, by appropriately selecting the antenna placement to avoid areas with excessively poor wireless quality, DAS offers the advantage of providing sufficient signal strength to terminals located in various positions within the industrial automation area, regardless of their specific locations.

In the case of using distributed antennas, the number of antennas used for transmission to one terminal may be plural. In a multi-point transmission using a distributed antenna system, transmission can be performed to a terminal using one or a plurality of antennas generally located around the terminal. In such a wireless communication environment utilizing DAS, space-time codes, and beamforming in the above 6 GHz channel, there is a need for a system that can achieve channel diversity and array gain, have limited feedback overhead from multiple transmission points, and improve overall transmission reliability by distributing power without exceeding the total maximum power of the distributed points.

The present disclosure described below may provide solutions for the following three aspects.

First, by mapping a codeword in a sparse form to multiple transmit antenna (RF chain) environments and transmitting it in a single spatial layer or multiple spatial layers, a transmit diversity can be obtained.

Second, space-time block codes can be applied by dividing beamforming groups in the frequency domain.

Third, by utilizing limited feedback information instead of full channel state information (CSI) at multiple points, the power of each transmission point can be controlled.

Meanwhile, systems aiming for high-reliability and low-latency wireless communication, such as industrial automation, require the use of Ultra-Reliable and Low Latency Communications (URLLC) technologies mentioned in the 5G NR standard. For example, Machine Type Communication (MTC) for device control and alarms in factories should satisfy communication reliability of 10⁻⁹ and communication latency in the range of 0.3 to 0.1 milliseconds. In the present disclosure disclosure, described below, methods utilizing multiple antennas and frequency diversity will be described to meet such high-performance requirements in wireless fading channels for encoded information bit signals.

A channel and frequency diversity may be obtained to increase transmit diversity. Therefore, in the present disclosure, a transmission method in which a transmit modulated signal is applied to an OFDM waveform, and a sparse space-frequency (time-frequency code rather than space-time code in the case of OFDM) block code is combined therewith will be proposed.

A sparse space-frequency block code (SSFBC) according to the present disclosure is in a distributed form, where a single codeword is dispersed among all the antennas at a transmitting node. In other words, even if there are multiple transmit antennas, a single codeword can be distributed to all of them or only to a subset of the transmit antennas. Additionally, the present disclosure provides methods to minimize the complexity and enhance the performance at a receiving node. Thus, the following will describe methods for both the transmitting and receiving nodes, which combine the SSFBC transmission technique and beamforming technique, taking into account both the transmitting and receiving nodes.

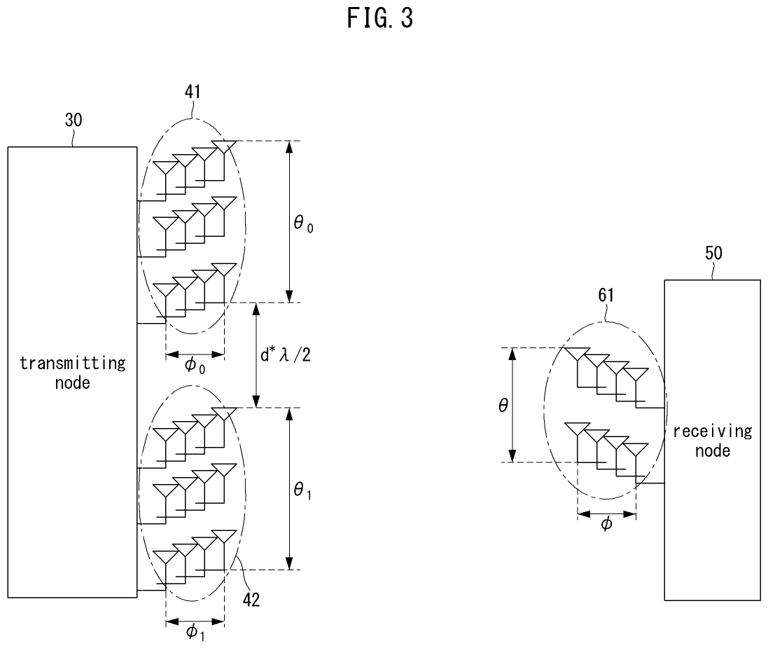

FIG. 3 is a conceptual diagram illustrating a transmitting node and a receiving node for describing an SSFBC transmission scheme to which a beamforming scheme is applied according to the present disclosure.

Referring to FIG. 3, a transmitting node 30 and a receiving node 50 are illustrated. The transmitting node 30 may include array antennas 41 and 42 each having a plurality of antenna elements for transmit beamforming, and the receiving node 50 may include an array antenna 61 having a plurality of antenna elements for receive beamforming.

The transmitting node 30 according to the present disclosure may be included in a base station, for example. One base station may be configured with a plurality of transmission and reception points (TRPs). When a base station is configured with a plurality of TRPs, each of the TRPs may include at least some components used for the base station to transmit signals. In addition, when a base station is configured with a plurality of TRPs, each of the TRPs may include all or at least some of the array antennas 41 and 42 shown in FIG. 3. In addition, the transmitting node 30 may control a transmit power when beamforming and transmitting a signal generated based on SSFBC according to the present disclosure over the air. In addition, when the base station according to the present disclosure beamforms and transmits data through a plurality of TRPs, the base station may control distribution and/or transmit powers of data to be transmitted by the respective TRPs.

In FIG. 3, a case where the transmitting node 30 has two different array antennas 41 and 42 is illustrated. However, the transmitting node 30 according to the present disclosure is not limited to having two array antennas. For example, when the transmitting node 30 according to the present disclosure is a TRP, the transmitting node 30 may have only one array antenna, or may have two or more array antennas as illustrated in FIG. 3. In addition, a case where the transmitting node 30 is a base station and the base station has two or more TRPs may be considered. The internal configuration of the transmitting node 30 illustrated in FIG. 3 will be described in more detail based on the drawings to be described later.

In the present disclosure, a form in which the transmitting node 30 transmits a desired signal through a plurality of different transmit antenna groups is exemplified. In FIG. 3, each of the two transmit array antennas 41 and 42 may be a transmit antenna group. On the other hand, in FIG. 3, only two transmit antenna groups are illustrated as the transmit array antennas 41 and 42, but the number of transmit antenna groups may be set differently based on what will be described below. Accordingly, in the following description, each of the array antennas 41 and 42 connected to or provided in the transmitting node 30 may be understood as corresponding to a transmit antenna group.

Further, a separation distance between the transmit antenna groups 41 and 42 may have a multiple of a natural number equal to ½ of a carrier wavelength λ. That is, in FIG. 3, d is a natural number, and it is exemplified that the separation distance between the antenna groups 41 and 42 may be a distance of d*λ/2.

The receiving node 50 may include the array antenna 61 for receive beamforming. The receiving node 50 may be implemented in various forms. For example, the receiving node 50 may be configured as a smart phone, a PDA, a notebook computer, a device for factory automation, and/or the like. In particular, according to the present disclosure, it may have a form capable of receiving and processing a signal according to URLLC technical specifications defined in the 5G NR standard. In addition, the receiving node 50 may include a configuration for receiving the signal transmitted by the transmitting node 30 by performing receive beamforming and demodulating and decoding the received signal. Since the transmitting node according to the present disclosure transmits a signal encoded based on the SSFBC scheme, the receiving node 50 may have a configuration for applying a decoding scheme corresponding thereto. The configuration of the receiving node 50 will be described based on the drawings to be described later.

The transmitting node 30 and the receiving node 50 of FIG. 3 described above may have a structure in which a channel space and a frequency-axis diversity are maximized in order to achieve high reliability and low latency of a signal transmitted between the two nodes.

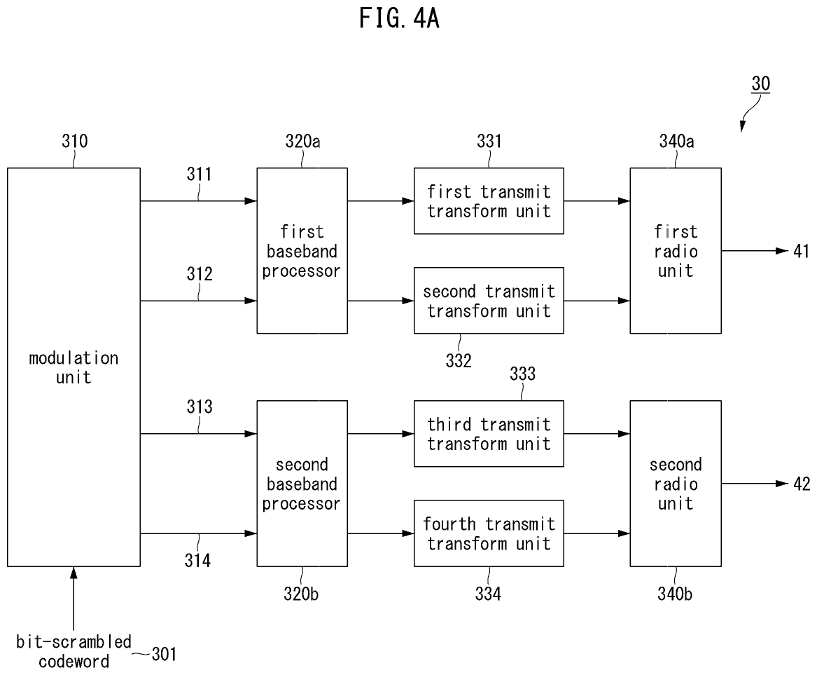

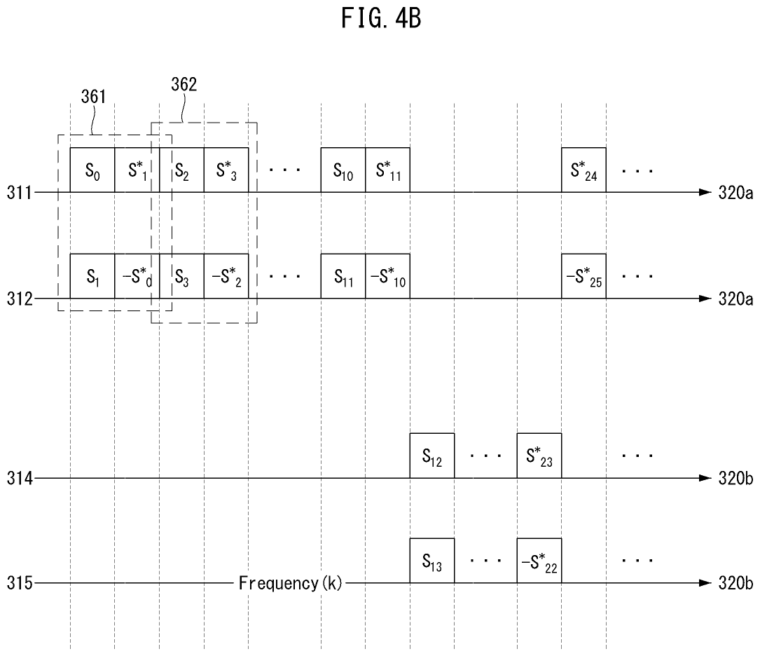

FIG. 4A is a conceptual diagram illustrating main configuration of a transmitting node for transmitting signals based on SSFBC according to the present disclosure.

It should be noted that, since FIG. 4A illustrates only a configuration for transmitting signals based on SSFBC, a configuration for the transmitting node 30 to receive signals fed back from the receiving node 50 is omitted.

Prior to describing the configuration and operation illustrated in FIG. 4A, a bit-scrambled codeword 301 to be transmitted by the transmitting node 30 according to the present disclosure will be described. The bit-scrambled codeword 301 may be input to a modulation unit 310. Here, the bit-scrambled codeword 301 may refer to bits obtained by coding and scrambling data (or information) to be transmitted. In addition, an encoding scheme may be performed, for example, in a manner agreed between the transmitting node and the receiving node, and a scrambling scheme may also be performed in a manner agreed between the transmitting node and the receiving node.

A process of generating the bit-scrambled codeword 301 will be described in more detail. The data to be transmitted by the transmitting node 30 may be in the form of a bit-stream. The data in the form of a bit stream, which is to be transmitted, may have a vector form. Cyclic Redundancy Check (CRC) bits may be appended to the data in the form of a bit stream, which is to be transmitted in the communication system. Since the length of the CRC bits may have various length values, further description on the length of the CRC bits will be omitted in the present disclosure.

The CRC-added bit stream may be input to an encoder, and the encoder may encode the CRC-added bit stream and output a codeword. In general, the encoder used in the communication system may be a channel encoder. The channel encoder may generate a codeword having a forward error correction (FEC) function. Also, the generated codeword may be scrambled by a scrambler. Then, the scrambled codeword may be input to a rate matching block based on a transmission rate. The rate matching block may adjust the length of the codeword to map the codeword to transmittable physical resources. For example, when the length of the codeword is short compared to the transmittable physical resources, rate matching may be performed through repetition. As another example, when the length of the codewords is long compared to the transmittable physical resources, rate matching may be performed by selecting only a part of the codeword to be transmitted.

The bit-scrambled codeword may be generated through the process described above. Accordingly, the bit-scrambled codeword 301 may be a baseband bit stream.

The modulation unit 310 may modulate the bit-scrambled codeword 301 based on a scheme agreed between the transmitting node 30 and the receiving node 50. The modulation unit 310 may separate the modulated signal into a plurality of signals and output them. To this end, the modulation unit 310 may include a switch or a multiplexer. Separation of the modulated signal at the modulation unit 310 may be determined based on the number of baseband processors. Referring to FIG. 4A, a configuration in which the transmitting node 30 includes a first baseband processor 320a and a second baseband processor 320b is exemplified. The modulation unit 310 may switch or multiplex the modulated signal and output it to the first baseband processor 320a and the second baseband processor 320b separately.

The signals output from the modulation unit 310 may be output as a predetermined number of modulated data units through two signal lines 311 and 312 toward the first baseband processor 320a, and then output as a predetermined number of modulated data units through two signal lines 313 and 314 toward the second baseband processor 320b. The signals output from the modulation unit 310 will be described with reference to the accompanying FIG. 4B. FIG. 4B is a conceptual diagram illustrating modulated signals output from a modulation unit according to the present disclosure.

Referring to FIG. 4B, signals at four signal lines output from the modulation unit 310 are illustrated. The signals output through the first signal line 311 may be expressed as S₀, S*₁, S₂, S*₃, . . . , S₁₀, S*₁₁. In addition, the signals output through the second signal line 312 may be expressed as S₁, −S*₀, S₃, −S*₂, . . . , S₁₁, −S*₁₀.

In this case, when the modulation unit 310 outputs the modulated signals through the first signal line 311 and the second signal line 312 as illustrated in FIG. 4B, it may not output the modulated signals through the third signal line 313 and the fourth signal line 314. Conversely, when the modulation unit 310 outputs the modulated signals through the third signal line 313 and the fourth signal line 314, the modulation unit 310 may not output the modulated signals through the first signal line 311 and the second signal line 312.

As shown in FIG. 4A, the signals output from the modulation unit 310 through the first signal line 311 and the second signal line 312 may be input to the first baseband processor 320a, and the signals output from the modulation unit 310 through the third signal line 313 and the fourth signal line 314 may be input to the second baseband processor 320b.

In addition, in FIG. 4B, a space-frequency block code (SFBC) scheme is illustrated as reference numerals 361 and 362. The SFBC scheme may use two signals to be transmitted through different array antennas (or different array antenna groups) for transmit diversity. The outputs from the modulation unit 310 will be described using the first SFBC block 361 illustrated in FIG. 4B.

The first signal line 311 of the modulation unit 310 may be a line that outputs symbols to be transmitted through a first subcarrier or a first subband, and the second signal line 312 may be a line the outputs symbols to be transmitted through a second subcarrier or a second subband. Assuming that the modulated symbols generated by the modulation unit 310 are S₀, S₁, S₂, and S₃, the modulation unit 310 may output the modulated symbol S₀ through the first signal line 311, and may output the modulated symbol S₁ through the second signal line 312 in order to generate the first SFBC block 361. In addition, the modulation unit 310 may output a symbol −S*₀ corresponding to the modulated symbol S₀ through the second signal line 312, and output a symbol −S*₁ corresponding to the modulated symbol S₁ through the first signal line 311.

As described above, modulated symbols included in the first SFBC block 361 may have a form in which two consecutive modulated symbols of the first signal line 311 and the second signal line 312 are transmitted as a group. The second SFBC block 362 may also be configured in the same form as the first SFBC block 361.

Meanwhile, as described above, the first signal line 311 and the second signal line 312 are signal lines input to the first baseband processor 320a, and the third signal line 313 and the fourth signal line 314 are signal lines input to the second baseband processor 320b. Accordingly, while the modulation unit 310 outputs the SFBC blocks 361 and 362 through the signal lines 311 and 312 input to the first baseband processor 320a, modulated symbols are not output to the signal lines 313 and 314 input to the second baseband processor 320b. In addition, while the modulation unit 310 outputs SFBC blocks (not shown in FIG. 4B) through the signal lines 313 and 314 input to the second baseband processor 320b, modulated symbols are not output to the signal lines 311 and 312 input to the first baseband processor 320a.

Therefore, the modulation unit 310 switches (or multiplexes) the outputs to the first baseband processor 320a and the second baseband processor 320b in a predetermined SFBC unit according to the above-described manner, thereby obtaining an SSFBC according to the present disclosure. In other words, an SFBC output to a specific antenna array has sparse characteristics. Therefore, a form to which the SSFBC scheme according to the present disclosure is applied may be achieved. Also, this feature may be understood as partially-connected group beamforming. However, the above-described SFBC application to the baseband and the operation applying sparse mapping of baseband signal to frequency-specific manner at different antenna groups may not be applied depending on the circumstances in which the transmitter detects line-of-sight channel conditions or the transmitter figures out the channel conditions for each beamforming groups are very different.

In addition, the above-described application of SFBC to the baseband and the operation of switching the output per frequency of the baseband for each antenna group may not be applied, when a situation occurs, such as a base station (transmitter) detects a channel condition with a terminal as a line of sight or determines that the channel condition between terminals is very different for each beamforming group.

In this situation, beamforming for each group may be performed by applying single stream beamforming. In other words, single-stream beamforming can be performed in a situation where SFBC is not applied, such as when channel conditions between UEs are very different for each beamforming group.

Referring again to FIG. 4A, the configuration of the transmitting node 30 will be described. The signals output from the modulation unit 310 of the transmitting node 30 may be inputted to the first baseband processor 320a and the second baseband processor 320a through the respective signal lines 311 to 314 as described above with reference to FIG. 4B. In other words, the first baseband processor 320a may receive the modulated signals through the two signal lines 311 and 312 connected to the modulation unit 310, and the second baseband processor 320b may receive the modulated signals through the other two signal lines 313 and 314 connected to the modulation unit 310.

The first baseband processor 320a and the second baseband processor 320b may have the same configuration. Each of the first baseband processor 320a and the second baseband processor 320b may perform baseband-precoding on the input modulated signals. Each of the first baseband processor 320a and the second baseband processor 320b may precode the input baseband signal using a baseband precoding matrix preconfigured in each of the baseband processors 320a and 320b. In this case, each of the first baseband processor 320a and the second baseband processor 320b may output the precoded signal to transmit transform units 331, 332, 333, and 334 separated according to the respective subbands. In other words, each of the first baseband processor 320a and the second baseband processor 320b may output the precoded signal by separating it to transmit it through a RF chain based on a corresponding frequency position (e.g., subband).

The first transmit transform unit 331 and the second transmit transform unit 332 may process the output of the first baseband processor 320a as illustrated in FIG. 4A, and the third transmit transform unit 333 and the third transmit transform unit 334 may process the output of the second baseband processor 320b. The first transmit transform unit 331 and the second transmit transform unit 332 connected to the first baseband processor 320a may perform inverse fast Fourier transform (IFFT) processing and addition of a cyclic prefix (CP) of an OFMDM symbol. Then, each of the first transmit transform unit 331 and the second transmit transform unit 332 may modulate the CP-added OFDM symbol into an OFDM waveform.

Each of the first transmit transform unit 331 and the second transmit transform unit 332 may correspond to one of RF chains separated into different subbands. In other words, the first transmit transform unit 331 may perform processing corresponding to a first RF chain for transmitting the CP-added OFDM waveform through multiple antennas. The second transmit transform unit 332 may also perform processing corresponding to a second RF chain for transmitting the CP-added OFDM waveform through multiple antennas.

Since all of the transmit transform units 331 to 334 described above have the same configuration, the third transmit transform unit 333 and the fourth transmit transform unit 334 may perform the same operations as those of the first transmit transform unit 331 and the second transform unit 332 described above. Accordingly, each of the transmit transform units 331 to 334 may include an IFFT processor, a CP adder, and an RF chain.

The first transmit transform unit 331 and the second transmit transform unit 332 may be connected to a first radio unit 340a, and the third transmit transform unit 333 and the fourth transmit transform unit 334 may be connected to a second radio unit 340b. In other words, signals output from the first transmit transform unit 331 and the second transmit transform unit 332 may be converted into RF band signals by the first radio unit 340a and then beamformed and transmitted to the receiving node through the first multi-antenna 41. In addition, signals output from the third transmit transform unit 333 and the fourth transmit transform unit 334 may be converted into RF band signals by the second radio unit 340b and then beamformed and transmitted to the receiving node through the second multi-antenna 42.

The configurations of FIGS. 4A and 4B described above have described an SSFBC transmission structure divided into two frequency subbands and beamforming groups. Two or more frequency subbands and beamforming groups will be further described below.

On the other hand, the configuration of the transmitting node 30 illustrated in FIG. 4A does not illustrate a configuration for receiving signals (or information) fed back by the receiving node 50. However, it is obvious that the transmitting node 30 has a configuration for receiving signals fed back by the receiving node 50, and a configuration for receiving a feedback signal may utilize various known methods. Therefore, in the present disclosure, further description on the configuration and operation of the transmitting node 30 receiving feedback signals from the receiving node 50 will be omitted.

In addition, two or more units performing the same function among the units illustrated in FIG. 4A may be implemented as one unit. The example of FIG. 4A is merely a configuration for convenience of understanding, and the communication node may not necessarily be implemented in the form of FIG. 4A. For example, when one baseband processor is capable of performing separate processings, such as the first baseband processor 320a and the second baseband processor 320b illustrated in FIG. 4A, the first baseband processor 320a and the second baseband processor 320b may be implemented as one baseband processor. This may be equally applied to the transmit transform units 331, 332, 333, and 334 and the radio units 340a and 340b.

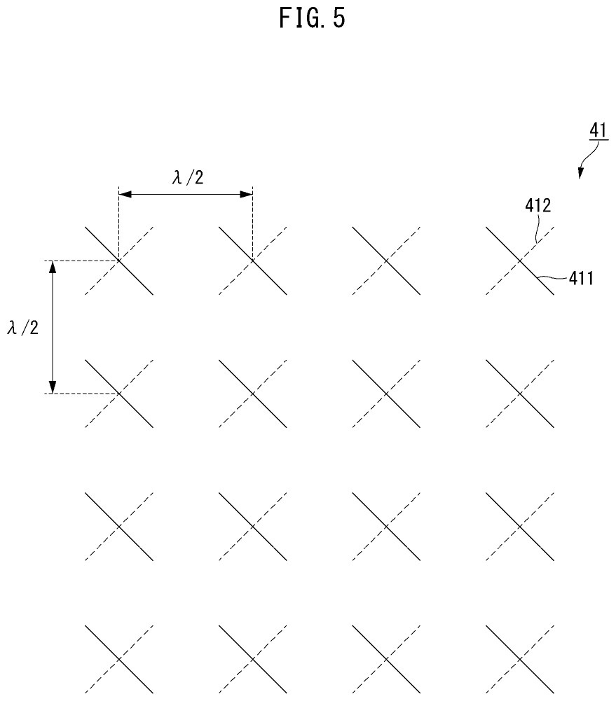

FIG. 5 is a diagram illustrating a case in which multiple antennas of a transmitting node are configured as cross-pole antennas according to an exemplary embodiment of the present disclosure.

Referring to FIG. 5, one cross-pole antenna may have a shape in which a first antenna element 411 and a second antenna element 412 cross each other at right angles. The 4×4 cross-pole antennas illustrated in FIG. 5 are one example, and may have more cross-pole antennas than the illustrated number. In such the cross-pole antenna, an intersection point of the first antenna element 411 and the second antenna element 412 and an intersection point of an adjacent cross-pole antenna may be spaced apart by a distance of a half of a carrier wave length (i.e., by λ/2 when λ is the carrier wave length).

In addition, since each antenna element of the cross-pole antenna operates as one antenna, FIG. 5 illustrates a case where the number of antenna elements (AEs) is 32.

FIG. 5 illustrates a configuration of a uniform planar array antenna. The uniform planar array antenna illustrated in FIG. 5 may be one of the multi-antennas 41, 42, and 61 illustrated in FIG. 3 above. For example, both the first array antenna 41 and the second array antenna 42 connected to the transmitting node 30 may have the same configuration as illustrated in FIG. As another example, the first array antenna 41 and the second array antenna 42 connected to the transmitting node 30 may have an extended form or a reduced form of the uniform planar array antenna illustrated in FIG. 5. As yet another example, the first array antenna 41 and the second array antenna 42 connected to the transmitting node 30 may be implemented as at least a part of the uniform planar array antenna illustrated in FIG. 5.

In the above, only the array antennas 41 and 42 connected to the transmitting node 30 or provided in the transmitting node 30 have been described, but the array antenna 61 connected to the receiving node 50 or provided in the receiving node 50 may also have the same form.

Therefore, the planar array antenna described above with reference to FIG. 5 may correspond to one array antenna described in FIG. 3.

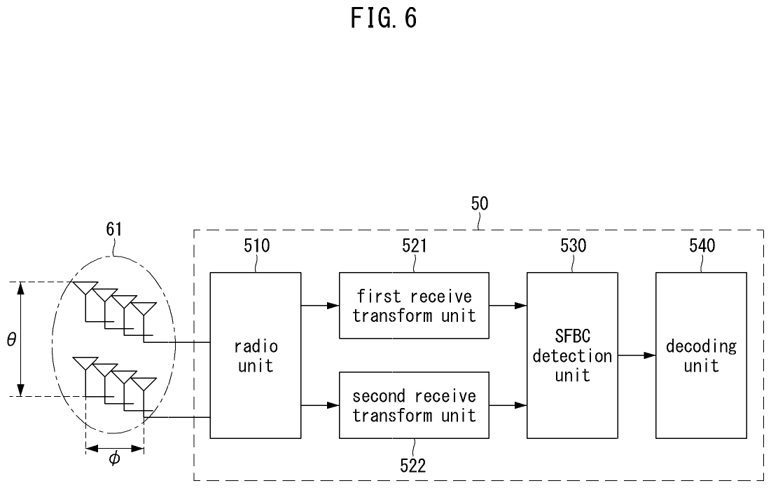

FIG. 6 is a conceptual diagram illustrating main configuration of a receiving node for receiving signals based on SSFBC according to the present disclosure.

The multi-antenna 61 may be multiple antennas required for the receiving node 50 to receive the SSFBC-coded signal. The multi-antenna 61 may be implemented as cross-pole antennas as described above with reference to FIG. 5. When the multi-antenna 61 is implemented as cross-pole antennas, the number of antenna elements of the multi-antenna 61 may be equal to or less than the number of antenna elements of each of the multi-antenna groups 41 and 42 included in the transmitting node 30. For example, when the number Nᵣ of receive antenna elements is 16, only two columns or two rows of the cross-pole antenna elements described in FIG. 5 may be configured. As another example, when the number Nᵣ of receive antenna elements is 32, it may have the same configuration as all of the cross-pole antenna elements described in FIG. 5.

Hereinafter, the receiving node 50 will be described. The receiving node 50 may include a radio unit 510, a first receive transform unit 521, a second receive transform unit 522, an SFBC detection unit 530, and a decoding unit 540.

The radio unit 510 may convert RF signals received from the multi-antenna 61 into baseband signals and output the converted baseband signals. The radio unit 510 may output the converted baseband signals to the first receive transform unit 521 and/or the second receive transform unit 522 based on the RF chain.

Since the first receive transform unit 521 and the second receive transform unit 522 may have the same configuration, only the configuration and operation of the first receive transform unit 521 will be described. The first receive transform unit 521 may remove the CP from the signal received from the radio unit 510 based on the RF chain, and perform a fast Fourier transform (FFT) to transform the frequency domain signal into a time domain signal. Accordingly, the OFDM signal may be transformed into the time domain signal and then provided to an SFBC detection unit 530. Accordingly, the first receive transform unit 521 and the second receive transform unit 522 may transform the OFDM signal into the time-domain signal by taking the signals based on the corresponding RF chains as inputs, and output the transformed time-domain signals to the SFBC detection unit 530, respectively.

The SFBC detection unit 530 may detect signals transmitted by the transmitting node 30 in the SFBC scheme, demodulate detected SFBC symbols, and output log likelihood ratio (LLR) values.

The decoding unit 540 may perform descrambling and channel-decoding based on the LLR values output from the SFBC detection unit 530. The descrambling may be performed in a manner corresponding to the reverse of the scrambling in the transmitting node 30. In addition, the channel decoding may be performed on the descrambled symbols based on the FEC function because the transmitting node 30 generates the codeword having the FEC function as described above with reference to FIG. 4A.

Meanwhile, in the receiving node 50 illustrated in FIG. 6, a configuration for transmitting signals (or information) to be fed back to the transmitting node 30 is not illustrated. However, it is obvious that the receiving node 50 has a configuration for transmitting feedback signals to the transmitting node 30, and a configuration for receiving the feedback signals may utilize various methods known to date. Therefore, in the present disclosure, further description on the configuration and operation of transmitting the feedback signals from the receiving node 50 to the transmitting node 30 will be omitted.

However, the receiving node 50 according to the present disclosure may use signals (e.g., synchronization signal block (SSB) or reference signal (RS) corresponding to transmitted data) transmitted by the transmitting node 30 to generate and transmit feedback information (or feedback signals).

In the above, the configuration and operation of the transmitting node 30 and the configuration and operation of the receiving node 60 have been described with reference to FIGS. 3 to 6. Hereinafter, the SSFBC transmission scheme in the transmitting node 30 according to the present disclosure will be described in more detail.

Looking again at the contents described with reference to FIG. 4A, the codeword bit stream modulated by the modulation unit may be denoted as S(●). The modulated codeword bit stream S(●) may be precoded based on a baseband precoding matrix in the first baseband processor 320a and/or the second baseband processor 320b. In addition, it may be mapped to M beamforming groups (or subband frequency regions) (i.e., beamforming group m (m=0, 1, 2, . . . , M−1). The mapping operation may be exemplified by Equation 1 below.

m=(k/f_{sub})mod(N_{RF}/2) [Equation 1]

In Equation 1, k is a frequency subcarrier index. f_{sub} is the length of a subband in the frequency domain, and N_{RF} is the total number of RF chains. For example, as described in FIG. 4A, when N_{RF} is 4, a range of m becomes two beamforming groups. In order to increase a diversity order, N_{RF} may be increased to increase the number of beamforming groups. However, when the total number N t of transmit antennas is fixed, the increase in the number of beamforming groups may lose an array gain. It can be seen that the SSFBC scheme according to the present disclosure has characteristics of sparse RF chain-frequency mapping when viewed at a baseband level.

Meanwhile, when the baseband precoding matrix is applied, the baseband processors 320a and 320b may apply the baseband precoding matrix based on information fed back from the receiving node 50.

The receiving node 50 may receive the signal transmitted by the transmitting node 30 as shown in Equation 2 below.

y=HF_{RF}F_{BB}s+n [Equation 2]

In Equation 2, y is the signal received at the receiving node 50, and H is a matrix of a product of the number Nₜ of transmit antenna elements (AEs) and the number Nᵣ of receive antenna elements. In other words, H is a matrix having a dimension of Nₜ×Nᵣ. In addition, F_{RF} is a matrix having a dimension of Nₜ×Nₛ, which is configured as a combination of beamforming steering vectors connecting the RF chain and the baseband. The vector s of a size Nₛ×1 is a transmission signal. Also, in Equation 2, F_{BB} is a baseband precoding matrix having a dimension of Nₛ×Nₛ, and n may be noise or additive white Gaussian noise.

The receiving node 50 may measure a condition number (CN) from the reception signal as shown in Equation 2, and may feedback phase values φ₀ and φ₁ and a binary number γ that 25 can lower the CN to a minimum value to the transmitting node 30. The CN is a standard measure of how ill-conditioned the matrix is at the receiving node 50.

The receiving node 50 may perform singular value decomposition (SVD) on an effective channel HF_{RF}F_{BB} s as shown in Equation 3 below. Here, F_{RF} may refer to a process performed by the first radio unit 340a and the second radio unit 340b of the transmitting node and F_{BB} may mean a process performed by the first baseband processor 320a and the second baseband processor 320a of the transmitting node 30.

HF_{RF}F_{BB}=UΣ_{F}_{_{BB}}V^{H} [Equation 3]

In Equation 3, U is a reception matrix of the receiving node 50, and V^{H} is a precoding matrix corresponding to a channel matrix.

As shown in Equation 3, the CN value may be determined as a ratio of the maximum value λₘₐₓ and the minimum value λₘᵢₙ of a diagonal matrix Σ_{F}_{_{BB}} in the values obtained from the SVD. In other words, the CN may be determined as a ratio λₘₐₓ/λₘᵢₙ of the maximum value and the minimum value of a diagonal matrix among the values obtained by performing the SVD on the effective channel.

Here, F_{BB}=[f₀ f₁] is composed of precoding vectors f₀ and f₁, and each vector is expressed with Equation 4 below.

f₀=(\sqrt{2})^{-γ}[1,γe^{jφ}^{₀}]^{T}

f₁=(\sqrt{2})^{-γ}[γe^{jΦ}^{₁},1]^{T} [Equation 4]

Meanwhile, F_{RF} is a matrix consisting of two beam steering column vectors q_{N}_{_{RF}} overlapped in each spatial stream, and each uniform planar array vector may be expressed as in Equation 5 below.

$${q}_{{N}_{R F}} = {g}_{{ϕ}_{H}} ⊗ {u}_{{θ}_{V}} {N}_{t} = K L {U}_{{θ}_{V} , k} = {\frac{1}{\sqrt{K}} [ 1 , {e}^{j π 1 c o s ( {θ}_{V} )} , … , {e}^{j π ( K - 1 ) c o s ( {θ}_{V} )} ]}^{T} {g}_{{ϕ}_{H} , l} = {\frac{1}{\sqrt{L}} [ 1 , {e}^{j π 1 s i n ( {ϕ}_{H} )} , … , {e}^{j π ( L - 1 ) s i n ( {ϕ}_{H} )} ]}^{T} \qquad [ Equation 5 ]$$

Meanwhile, in the present disclosure, a multi-point transmission scheme may be considered for a terminal located at a cell edge in order to improve the reliability of URLLC communication, as well as the robustness of the point-to-point transmission scheme.

In the case of an inter-cell situation, additional performance improvement may be expected through a power allocation method applicable to the multi-point signal transmission. The conventional distributed TRP power allocation schemes have proposed an optimal power allocation scheme under the assumption that downlink full channel state information (CSI) is known. However, such the scheme requires a large overhead. Therefore, the present disclosure proposes a method of applying power allocation using a transmission angle and a channel quality index of each transmission point instead of CSI requiring a large overhead.

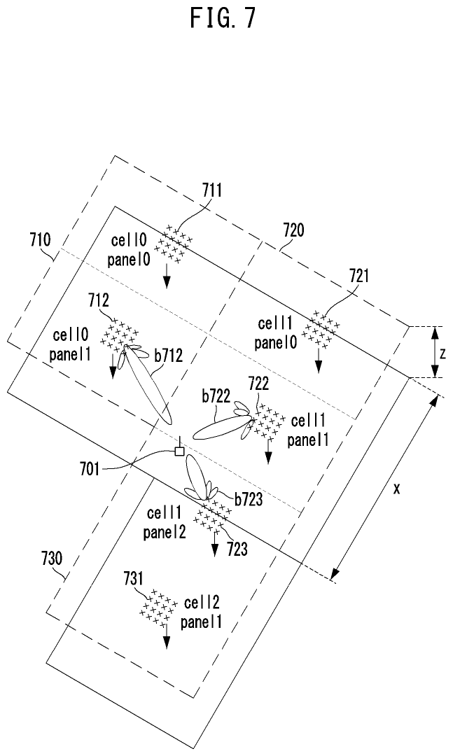

FIG. 7 is a conceptual diagram for describing a distributed panel multi-point transmission scheme for a terminal located at a cell edge according to the present disclosure.

Referring to FIG. 7, a plurality of cells 710, 720, and 730 are illustrated. Each of the cells 710, 720, and 730 may include one or more panels. For example, the cell 0 710 may include a panel 0 711 and a panel 1 712, the cell 1 720 may include a panel 0 721, a panel 1 722, and a panel 2 723, and the cell 2 730 may include a panel 1 731.

The panels 711, 712, 721, 722, 723, and 731 illustrated in FIG. 7 may correspond to one array antenna connected to the transmitting node 30 illustrated in FIG. 3. This will be described for the cell 0 710 with reference to the configuration of FIG. 3.

The cell 0 710 may be a region managed by one transmitting node 30 or a region for communication between the transmitting node 30 and a terminal (e.g., receiving node). The configuration of the transmitting node 30 may include the configuration of FIG. 4A described above. It should be noted that FIG. 7 does not illustrate the position of the transmitting node 30. Also, the panel 0 and the panel 1 within the cell 710 may correspond to the transmit array antennas 41 and 42 of FIG. 3, respectively. For example, when the panel 0 711 corresponds to the first transmission array antenna 41, the panel 1 712 may correspond to the second transmission array antenna 42. Also, each of the panels 711 and 712 may have a cross-pole antenna structure based on the description with reference to FIG. 5. In other words, each of the panels 711 and 712 may be configured in the form of a planar array antenna having a cross-pole structure.

In FIG. 7, a case in which the cell 1 720 has three or more transmit array antennas is exemplified. Since FIG. 7 may correspond to a case in which only a part of the configuration of the cell is illustrated, the number of transmit array antennas is not limited to that illustrated in FIG. 7. For example, only the panel 1 731 of the cell 2 730 is exemplified. In other words, it should be noted that the panel 0 of the cell 2 730 is not illustrated in FIG. 7.

Each of the cells 710, 720, and 730 illustrated in FIG. 7 may correspond to one base station or access point (AP). Hereinafter, for convenience of description, it is assumed that each of the cells 710, 720, and 730 corresponds to one base station.

A base station may arrange a plurality of panels for transmitting and receiving RF signals in different places. In other words, the plurality of panels may correspond to TRPs referred to in the mobile communication system.

In FIG. 7, a case in which a terminal 701 is located within the cell 1 720 is exemplified. More specifically, the terminal 701 may be located in a region of the panel 2 723 in the region of the cell 1 720 and located at an edge of the region of the panel 2 723. Therefore, in the terminal 701 located at the edge of the region of the panel 2 723, a strength of signals received from the panel 2 723 may not be sufficient. Accordingly, in the present disclosure, cooperative communication with other panels may be performed.

Referring to FIG. 7, a beam b723 formed by the panel 2 723 of the cell 1 720 for the terminal 701 is illustrated. Also, the terminal 701 is adjacent to an outer edge of the panel 1 722 of the cell 1 720. Accordingly, the panel 1 722 of the cell 1 720 may form a beam b722 for the terminal 701. In addition, the terminal 701 is adjacent to an outer edge of the panel 1 712 of the cell 0 710. Accordingly, the panel 1 712 of the cell 0 710 may form a beam b712 for the terminal 701.

As exemplified in FIG. 7, when the different panels 712, 722, and 723 respectively form the beams b712, b722, and b723 for the terminal 701 to perform cooperative communication, the terminal 701 may obtain a gain by combining signals based on the cooperative communication. In this case, transmit powers of the formed beams b712, b722, and b723 may be controlled based on distances between the respective panels 712, 722, and 723 and the terminal 701.

The operation method of each panel, which is the transmitting node based on the configuration of FIG. 7 described above, and the operation of the terminal, which is the receiving node, will be described.

Since each transmission TRP structure of the multi-point system according to the present disclosure applies single-user DFT-based beamforming, it provides the largest array gain. However, this may cause interference to downlink signals of other users. Downlink interference within a cell may be processed by handling resource allocation through appropriate multiplexing and downlink/uplink scheduling of the base station. However, the method of handling resource allocation through scheduling of the base station has limitations in increasing spectral efficiency. The transmitting node for DFT-based beamforming described above with reference to FIGS. 3 to 6 may cause significant inter-cell interference to other downlink data signal receiving users located at cell edges. In addition, as illustrated in FIG. 7, when the terminal 701 is located at an inter-cell boundary, it may experience significant interference. Therefore, performance can be improved if it is switched to active transmission in which other base stations participate in cooperation through joint multi-point signal transmission in an environment of being interfered with other base stations.

Such the inter-cell multi-point transmission technology may be implemented through a multi-point coordinated communication scheme named ‘Coordinated Multi-point (CoMP)’ in the 3GPP LTE. A terminal may generally provide CSI or a channel quality indicator (CQI) to a base station participating in transmission.

As in CoMP, a network aggregate capacity can be optimized if CSIs for all transmission points participating in cooperative communication are provided. A scheme in which distributed base station panels (or TRPs) transmit data to a user equipment (UE) as illustrated in FIG. 7 may be regarded as a distributed antenna system (DAS).

In the DAS, power allocation of each distributed base station panel (or TRPs) plays an important role in improving a channel. Most schemes proposed for power allocation for distributed base station panels (or TRPs) in the DAS assume that a transmitting node knows downlink CSI. In other words, the power allocation method for distributed base station panels (or TRPs) in the DAS assumes that accurate downlink CSI is known.

However, in the present disclosure, distributed base station panels (or TRPs) utilize each transmit beam direction, CQI, and feedback traffic instead of accurate downlink CSI. Here, the transmission beam direction may be a zenith of departure (ZoD) and/or an angle of departure (AoD).

In addition, the present disclosure proposes a method in which distributed base station panels (or TRPs) perform angle and CQI based power allocation (ACPA) with low latency.

The distributed base station panels or TRPs adjacent to a terminal (e.g., UE) that is a receiving node may form a cooperative TRP group. Hereinafter, it should be noted that distributed base station panels and TRPs may be understood as having the same meaning, so even if used interchangeably, they should be understood as the panels in FIGS. 3 to 5. A multi-point transmission set and/or panels of each base station may be defined as P={Pᵢ| P₀, P₁, . . . , P_{I-1}}, and has a bound of Pᵢ∈[Pₘᵢₙ, Pₘₐₓ]. Then, a utility function of the i-th TRP may be defined as in Equation 6 below.

$${log}_{2} ( 1 + \frac{{P}_{i} {Ω}_{i} ( 1 - β ) + β {q}_{i}}{{\sum }_{∖ i ∈ I} ( {Ω}_{∖ i} ( 1 - β ) + β {q}_{∖ i} ) + {N}_{o}} ) - α {P}_{i} \qquad [ Equation 6 ]$$

In Equation 6, P_{\i} represents a power of a TRP (e.g., panel) of a base station other than a base station i in the cooperative transmission set. Nₒ is a noise power factor, and α represents a penalty of interference caused by the i-th TRP to downlink channels of other TRPs. β is a weight ratio between an angle-based channel power and a CQI level to determine an estimated channel gain of each TRP. qᵢ is a CQI value of the i-th TRP. Ωᵢ is an estimated long-term channel gain coefficient, and a radiation pattern according to an angle may be based on TR 38.901 among 3GPP technical specifications. Also, the receiving node may estimate ZoD/AoD and express the estimated long-term channel gain coefficient Ωᵢᵢ, as in Equation 7 below.

$${Ω}_{i} = 1 {0}^{\frac{- min \{ ( min \{ 12 ( \frac{Z o D - 90 °}{65 °} ) , 30 \} + min \{ 12 ( \frac{A o D}{65 °} ) , 30 ) ) , 30 \}}{10}} + β \qquad [ Equation 7 ]$$

The terminal may acquire ZoDs/AoDs and CQI information of TRPs other than the i-th TRP based on Equation 7 above, and transmit them to the i-th TRP. In other words, the terminal may obtain ZoDs/AoDs and CQI information of all TRPs and report them to each TRP. When the terminal reports to the i-th TRP, the terminal may report only ZoDs/AoDs and CQI information of other TRPs other than the i-th TRP to the i-th TRP. Accordingly, each of all the TRPs performing cooperative transmission may obtain ZoDs/AoDs and CQI information of TRPs other than itself.

Each TRP may find a value of a that satisfies a constraint of Equation 8 below in order to determine its transmit power based on the obtained information.

$${P}_{i}^{opt} = {argmax}_{{P}_{i}} {u}_{i} ( {P}_{i} , {P}_{∖ i} ) , {P}_{i} ∈ [ {P}_{min} , {P}_{max} ] s . t . {α}_{i , min} \leq α < {α}_{i , max} , {P}_{max} \approx {\sum }_{i}^{I} {P}_{i} \qquad [ Equation 8 ]$$

In order to find Pᵢ^{opt} in Equation 8,

$$\frac{\partial {u}_{i} ( {P}_{i} , {P}_{∖ i} )}{\partial {P}_{i}} = 0$$

may be applied to obtain a solution as shown in Equation 9 below.

$${P}_{i}^{opt} = \frac{1}{α ln 2} - \frac{{\sum }_{∖ i ∈ I} ( {Ω}_{∖ i} ( 1 - β ) + β {q}_{∖ i} ) + {N}_{o}}{{Ω}_{i} ( 1 - β ) + β {q}_{i}} \qquad [ Equation 9 ]$$

When the calculated power is as Pᵢ^{opt}≤0, then Pᵢ^{opt} may be set to 0.

Pᵢ calculated based on Equation 6 should satisfy bounds of Equation 10 below.

$${α}_{i , min} := \frac{1}{ln 2} {( {P}_{max} + \frac{{\sum }_{∖ i ∈ I} ( {Ω}_{∖ i} ( 1 - β ) + β {q}_{∖ i} ) + {N}_{o}}{{Ω}_{i} ( 1 - β ) + β {q}_{i}} )}^{- 1} \qquad [ Equation 10 ]$$

$${α}_{i , max} := \frac{1}{ln 2} {( {P}_{min} + \frac{{\sum }_{∖ i ∈ I} ( {Ω}_{∖ i} ( 1 - β ) + β {q}_{∖ i} ) + {N}_{o}}{{Ω}_{i} ( 1 - β ) + β {q}_{i}} )}^{- 1}$$

Based on the method described above, an example of a power allocation method as shown in FIG. 7 will be described with respect to the TRPs having the configurations of FIGS. 3 to 6. That is, in the situation illustrated in FIG. 7, each of the TRPs may correspond to one panel. The power allocation method for each TRP will be described by assuming that the configuration for transmitting signals to the panels is based on the description of FIG. 4A and FIG. 4B.

First, since each panel in FIG. 7 corresponds to one TRP, the correspondence relationship may be assumed as follows. Assumed is a case in which ZoD₀/AoD₀ as a transmission beam direction from the panel 1 712 of the cell 0 710 to the terminal 701 is 130°/60°, ZoD₁/AoD₁ as a transmission beam direction from the panel 1 722 of the cell 1 720 to the terminal 701 is 100°/10°, and ZoD₂/AoD₂ as a transmission beam direction from the panel 2 723 of the cell 1 720 to the terminal 701 is 110°/20°. In addition, it is assumed that α=0.618 as a penalty for interference by the i-th TRP, β=0.25, CQI qᵢ is all 0.5, Pₘₐₓ=1, and Pₘᵢₙ=0.001

Under the assumptions exemplified above, the transmit power of each i-th TRP may be calculated as follows through Equation 9.
(1) The transmit power from the panel 1 712 of the cell 0 710 to the terminal 701 is as P₀=0.
(2) The transmit power from the panel 1 722 of the cell 1 720 to the terminal 701 is as P₁=0.76.
(3) The transmit power from the panel 2 723 of the cell 1 720 to the terminal 701 is P₂=0.24.

It can be seen that the above result values satisfy the bounds of Equation 8. When the CQI is not provided, the transmit powers may be determined by setting β to 0. In the above description, it is assumed that multiple panels are used in two or more cells. However, it should be noted that the method described above may be equally applied even when multiple panels are used within one cell.

On the other hand, as illustrated in FIG. 7, in the method for grouping of TRPs that transmit downlink signals for the terminal 701 at the cell edge, the grouping may be performed in an initial access step, may be performed during communication, or may be performed in various cases such as handover or beam detection failure.

On the other hand, in order for the transmitting node 30 described in FIGS. 3 and 4a to operate based on the method shown in FIG. 7, additional configurations may be required to the components described in FIG. 4A. A brief description on this will be given.

As described above, the transmitting node 30 may receive feedback information provided from the receiving node 50. Accordingly, the transmitting node 30 may further include a feedback reception unit for receiving the feedback information. In this case, the feedback reception unit may receive feedback information corresponding to the signals transmitted by the transmitting node 30. In other words, as described above, the feedback reception unit of the transmitting node 30 may transmit channel quality information and/or beam angle information corresponding to the signals beamformed and transmitted by the transmitting node 30 to the receiving node 50 as the feedback information (or signal).

In addition, the transmitting node 30 may receive information on the transmit powers and/or reception beam angles of other adjacent TRPs (or other panels other than the panel transmitting the signals among the distributed base station panels) from the receiving node 50. At least some of the feedback information may be received through the receiving device. The feedback referred to in the present disclosure maybe understood from the equations described above.

The transmitting node 30 may also determine its transmit power based on the received feedback information. The transmitting node 30 illustrated in FIG. 4A may further include a transmit power determination unit for determining the transmit power. Further, the transmit power determination unit may provide information on the determined transmit power to each of the radio units 340a and 340b illustrated in FIG. 4A. The radio units 340a and 340b illustrated in FIG. 4A may determine a transmit power of an OFDM waveform signal based on the transmit power value provided from the transmit power determination unit. To this end, each of the radio units 340a and 340b may include a device for amplifying power therein, for example, a power amplifier.

According to the exemplary embodiments of the present disclosure described above, a spatial diversity can be obtained and a transmission reliability can be increased using a massive transmit antenna. In particular, it is possible to maintain a diversity order corresponding to the number of transmit antennas through appropriate adjustment of the number of beamforming groups and to maximize reliability of wireless communication transmission while requiring feedback components of low complexity. In addition, since limited feedback has an effect of lowering overhead, it can contribute to improving reliability by reducing an uplink transmission amount.

In addition, according to the exemplary embodiments of the present disclosure described above, a spatial diversity and a frequency diversity using multiple antennas can be obtained through sparse frequency resource allocation in the baseband. Therefore, the present disclosure can easily have compatibility with the existing standards such as 3 GPP. In addition, the methods proposed in the present disclosure can be relatively easily applied in terms of performance and implementation. Above all, it can be a good element technology for next-generation wireless transmission.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a transmitting node, comprising:
modulating a codeword corresponding to data to be transmitted;
generating sparse space-frequency block code (SSFBC)-coded symbols by encoding the modulated codeword in an SSFBC scheme;
performing precoding on the SSFBC-coded symbols for each of subbands respectively corresponding to transmit antenna groups; and
transmitting the precoded SSFBC-coded symbols by performing beamforming on the precoded SSFBC-coded symbols using at least one array antenna group among two or more array antenna groups.

2. The method according to claim 1, wherein a number of the subbands is determined based on a number of radio frequency (RF) chains.

3. The method according to claim 1, wherein the precoding is determined based on feedback information received from a receiving node, and the feedback information includes phase value(s) for lowering a condition number (CN) measured by the receiving node based on a signal received from the transmitting node to a minimum value.

4. A method of a first transmitting node, comprising:
modulating a codeword corresponding to data to be transmitted;
generating sparse space-frequency block code (SSFBC)-coded symbols by encoding the modulated codeword in an SSFBC scheme;
performing precoding on the SSFBC-coded symbols for each of subbands respectively corresponding to transmit antenna groups based on first feedback information related to the first transmitting node and second feedback information related to a second transmitting node; and
transmitting the precoded SSFBC-coded symbols by performing beamforming on the precoded SSFBC-coded symbols using at least one array antenna group among two or more array antenna groups based on the first feedback information and the second feedback information.

5. The method according to claim 4, further comprising: determining a transmit power based on the first feedback information and the second feedback information, wherein the precoded SSFBC-coded symbols are transmitted using the determined transmit power.

6. The method according to claim 5, wherein the first feedback information includes information on a zenith of departure (ZoD) and an angle of departure (AoD), which is information of a transmission beam direction.

7. The method according to claim 4, wherein the first transmitting node and the second transmitting node are transmission and reception points (TRPs) that transmit data to a same receiving node.

8. The method according to claim 4, wherein each of the first feedback information and the second feedback information includes interference penalty information of a different transmitting node performing cooperative transmission.

9. The method according to claim 5, wherein the second feedback information includes information on a transmit power of the second transmitting node.

10. The method according to claim 4, wherein a number of the subbands is determined based on a number of radio frequency (RF) chains.

11. A first transmitting node comprising a processor, wherein the processor causes the first transmitting node to perform:
modulating a codeword corresponding to data to be transmitted;
generating sparse space-frequency block code (SSFBC)-coded symbols by encoding the modulated codeword in an SSFBC scheme;
performing precoding on the SSFBC-coded symbols for each of subbands respectively corresponding to transmit antenna groups based on first feedback information related to the first transmitting node and second feedback information related to a second transmitting node; and
transmitting the precoded SSFBC-coded symbols by performing beamforming on the precoded SSFBC-coded symbols using at least one array antenna group among two or more array antenna groups based on the first feedback information and the second feedback information.

12. The first transmitting node according to claim 11, wherein the processor causes the first transmitting node to perform: determining a transmit power based on the first feedback information and the second feedback information, wherein the precoded SSFBC-coded symbols are transmitted using the determined transmit power.

13. The first transmitting node according to claim 11, wherein the first feedback information includes information on a zenith of departure (ZoD) and an angle of departure (AoD), which is information of a transmission beam direction.

14. The first transmitting node according to claim 11, wherein the first transmitting node and the second transmitting node are transmission and reception points (TRPs) that transmit data to a same receiving node.

15. The first transmitting node according to claim 11, wherein each of the first feedback information and the second feedback information includes interference penalty information of a different transmitting node performing cooperative transmission.

16. The first transmitting node according to claim 11, wherein the second feedback information includes information on a transmit power of the second transmitting node.

17. The first transmitting node according to claim 16, wherein a number of the subbands is determined based on a number of radio frequency (RF) chains.
